(19) United States
(12) Patent Application Publication
(10) Pub. No.: US 2008/0114727 A1
(43) Pub. Date: May 15, 2008

(54) UNIVERSAL STATISTICAL DATA MINING COMPONENT

(75) Inventors: PATRICK R. LEE, Bolingbrook, IL (US); Bruce A. DeFrang, Batavia, IL (US); Darrell J. Kooy, Aurora, IL (US)

Correspondence Address: PILLSBURY WINTHROP SHAW PITTMAN, LLP, P.O. BOX 10500, MCLEAN, VA, 22102, US

(73) Assignee: Computer Associates Think, Inc., Islandia, NY (US)

(21) Appl. No.: 11/558,278

(22) Filed: Nov. 9, 2006

(51) Int. Cl. G06F 17/30

(52) U.S. Cl. 707/3; 707/103 R; 707/E17.055; 707/E17.014

(57) ABSTRACT

The invention provides a system and method for extracting, storing, accessing, and/or analyzing statistical data from a plurality of software applications. In one embodiment, the invention includes a statistical data mining application and a universal application programming interface that extracts data summary objects from the plurality of software applications according to one or more extraction parameters using known policies regarding the application programming interfaces of the plurality of software applications. The policy knowledge is used by the universal application programming interface to translate data extraction requests of the statistical data mining application.

### FIELD OF THE INVENTION

The invention relates to a system and method for extracting, storing, analyzing, and/or accessing application summary data from multiple software applications.

### BACKGROUND OF THE INVENTION

Many computer applications, programs, and products receive, produce, utilize, and/or manipulate a wide variety of data objects and relationships between data objects in their day to day operation. These data objects and relationships are often vital to the operation and support of tasks performed by these computer applications. However, these data objects and relationships may also serve other purposes when aggregated, analyzed, and/or considered in any number of different contexts.

For example, these data objects are often used to derive statistical, summary, or other information regarding usage, efficiency, or other aspects of software application operation. In some instances, this statistical, summary, or other information is derived by the individual software applications themselves or by a companion data mining application.

In some cases, individual software applications or companion data mining applications produce “data summarization objects” representing this statistical or summary information. These data summarization objects may then be stored in a data warehouse that is associated with original software application. The stored summary data may then be mined for the relevant statistical or summary information.

In some instances, data summarization objects or other statistical or summary data is accessed by, for example, a companion application, using an application programming interface (API) unique to the original software application. These companion applications provide for proprietary querying, reports, or other uses, but fail to make a wide variety of statistical or summary data available for consumption, via a normalized method, in a normalized schema, for end users.

In addition, access to and use of statistical or summary data becomes difficult when multiple software applications are considered. This is due in part because different software applications utilize different APIs for interface with their data objects and/or data summarization objects. As such, access to and use of data summarization objects from a variety of different software applications mandates the use of a variety of different API's, and thus a variety of different companion applications. A user desiring to access statistical or summary information from multiple software applications would be required to understand the different APIs utilized by each software application. In light of these and other shortcomings of conventional systems, a common interface for gathering data summarization objects from different software applications and storing those data summarization objects in a normalized format would be a useful tool in providing support for the mining of statistical or summary information from diverse software applications.

### SUMMARY OF THE INVENTION

The invention solving these and other problems of conventional systems relates to a system and method for extracting, storing, analyzing, and/or accessing application summary data from multiple software applications. The invention provides a universal application extraction interface to multiple software applications. The universal interface enables the extraction, manipulation, querying, reporting, and/or other use of statistical or summary data regarding data produced/used by the multiple software applications. The universal interface is generic, such that it may interact with the application program interfaces (APIs) of multiple software applications and extract data summarization objects to a shared database. This universal interface enables the standardization of the administration of policies for statistical database population and reporting. Furthermore, universal data population techniques may be used to create, update, and warehouse statistical, summary, or other information via user-defined policies.

In some embodiments, the invention also provides a normalized data resource stored in a normalized schema, which may be mined and accessed using data mining and access techniques. Access to this normalized data may include using it as input for reporting or querying subsystems. Some or all of this normalized data may be utilized, for example, for cross-product integration of one or more of software applications, regulatory recording and/or reporting compliance, configuration management, and/or for other uses. The universal components/interfaces of the invention enable any type of statistical or summary reporting to be standardized, thus saving development and implementation resources.

In some embodiments, a system for extracting, storing, analyzing, and/or accessing application summary data from multiple software applications according to the invention may include a statistical data mining application, a universal application extraction interface, a summary database, a normalization module, a data access module, a reporting module, and/or other modules or elements.

In some embodiments, a plurality of software applications, each with its own individual application programming interface (API) may interact with the statistical data mining application via the universal application extraction interface. An individual software application may interface with the universal application extraction interface to extract any type of data, including data summarization objects to be used as part of a statistical data mine.

In some embodiments, the universal application extraction interface may include a data collection module. The data collection module may be configured to extract data of one or more types from one or more software applications and/or databases utilized by the one or more software applications. In some embodiments, the data collection module includes policies that instruct access to data from various individual software applications, including summary data objects. These policies include knowledge of how each of the various individual software applications grant access to their data summarization objects and thus enables the universal extraction interface to access and extract data summarization objects from each of the various individual software applications.

In some embodiments, the statistical data mining application includes a normalization module that normalizes data summarization data objects extracted from each of the individual software applications. The normalized data objects may be stored in the summary database according to various embodiments of the invention.

The statistical data mining application may also include a data access module that enables access to normalized data stored in the summary database. In some embodiments, a user or application may access the normalized data via, for example, a query engine according to a given set of query parameters. In these instances the data access module may provide the query engine.

The statistical data mining application may also include a reporting module. The reporting module may utilize the data in the summary database and/or the results from a query to generate reports that contain certain statistical, summary, or other information regarding the software applications and/or the relationships therebetween according to a set of reporting parameters.

In some embodiments, the invention provides a method for extracting, storing, analyzing, and/or accessing application data summarization objects from multiple software applications. In some embodiments, one or more data extraction parameters may first be defined. The data extraction parameters may include the type of data summarization objects to be extracted from one or more software applications, the source of the data summarization objects (e.g., which software applications to extract from), the timing of extraction (specific date/time, weekly, monthly, etc.), the format in which the data summarization objects will be stored, and/or other parameters.

The defined data summarization objects may then be extracted according to the defined extraction parameters. The extracted data summarization objects may then be normalized into a common format and stored in the summary database. In some embodiments, the common format may be the format specified by the extraction parameters. In some embodiments, the stored summary data may be accessed by one or more users, one or more modules, and/or by other methods. For example, the stored summary data may be accessed by the query module the reporting module, or other modules

These and other objects, features, and advantages of the invention will be apparent through the detailed description and the drawings attached hereto. It is also to be understood that both the foregoing summary and the following detailed description are exemplary and not restrictive of the scope of the invention.

### BRIEF DESCRIPTION OF THE DRAWINGS

FIG. 1 illustrates an example of a system for extracting, storing, analyzing, and/or accessing application summary data from multiple software applications, according to an embodiment of the invention.

FIG. 2 illustrates an example of a universal application extraction interface, according to an embodiment of the invention.

FIG. 3 illustrates an example of a process for extracting, storing, analyzing, and/or accessing application summary data from multiple software applications, according to an embodiment of the invention.

### DETAILED DESCRIPTION

The invention provides a system and method for extracting, storing, analyzing, and/or accessing application summary data from multiple software applications. The invention provides a universal application extraction interface for multiple software applications. The universal extraction interface enables the creation, manipulation, querying, reporting, and/or other use of statistical, summary, or other data regarding the data objects of those software applications. The universal extraction interface is generic, such that it may interact with the application program interfaces (APIs) of multiple software applications and extract data summarization objects to a shared database. The data stored in the shared database may then be normalized for ease of access and manipulation.

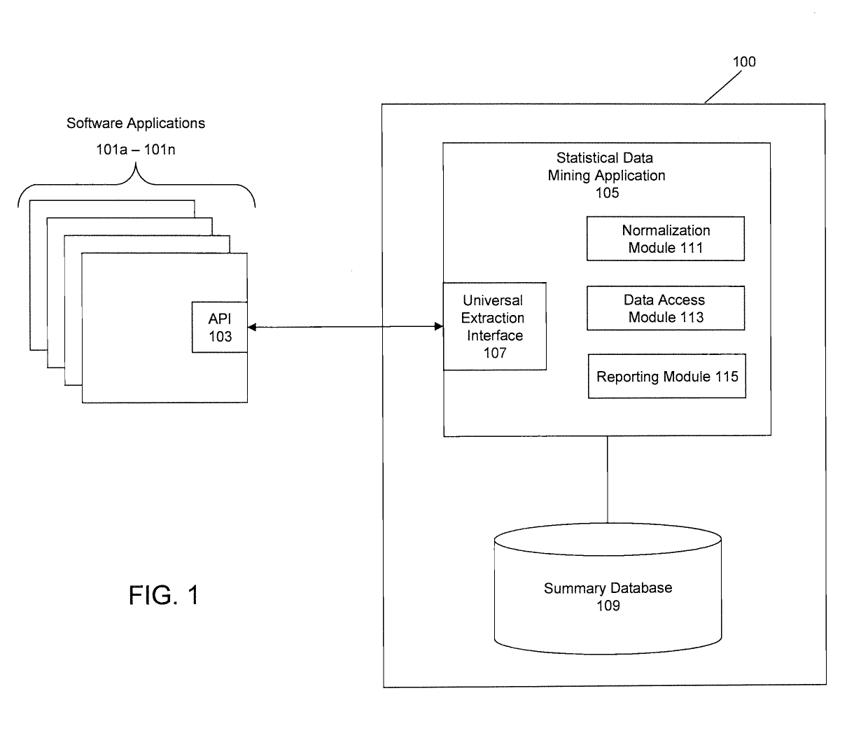

FIG. 1 illustrates a system 100 for extracting, storing, analyzing, and/or accessing application summary data from multiple software applications, according to an embodiment of the invention. System 100 may include a statistical data mining application 105, a universal application extraction interface (AEI) 107, a summary database 109, a normalization module 111, a data access module 113, a reporting module 115, and/or other modules or elements.

In some embodiments, a plurality of software applications 101 (illustrated in FIG. 1 as applications 101a-101n), each with its own individual application programming interface (API) 103, may communicate with statistical data mining application 105. Applications 101 may include one or more computer applications, modules, products, or other computer programs.

Each software application 101 may interact with statistical data mining application 105 via universal application extraction interface 107. Each individual software application 101 may interact with universal application extraction interface 107 to insert or modify any statistical data, in essence, sharing their data objects, including data summarization objects, with statistical data mining application 105.

In some embodiments, statistical data mining application 105 may be configured to collect data (e.g., data summarization objects) from software applications 101, and normalize the data into a normalized format. As such, statistical data mining application 105 may include normalization module 111 that converts data received from software applications 101 into a common format. The normalization is performed via the use of a generic schema that represents totals by name, type, value and data range. This simple normalization format allows applications to add and modify the simple schema through universal application extraction interface 107.

Statistical data mining application 105 may also include a data access module 113 that enables users to access or retrieve data stored in summary database 109 according to a given set of instructions. In some embodiments, data access module 113 may enable a user to provide “query parameters” for querying the stored data via a graphical user interface. The query parameters may specify, for example, the type of data to be returned by the query, the software application from which the data originated, and/or any other query parameters. Data access module 111 may receive queries in any number of query formats and may process queries using any known or proprietary dataset search and retrieval technique. In some embodiments, the query format may include elements of a standard SQL statement. These include filtering and sorting of statistical data. The normalized format is a simple schema to support simple query methods. Other query formats may be used, as would be apparent.

In some embodiments, statistical data mining application 105 may include a reporting module 115. Reporting module 115 may utilize the data in summary database 109 and/or the results from a query to generate reports that contain certain statistical or other information regarding software applications 101 according to a set of report parameters. In some embodiments, reporting module 115 may enable a user to provide report parameters for generating reports via a graphical user interface. These report parameters may specify, for example, the type of data and/or software application of origin of the data to be used in the report (e.g., “report data parameters”), the frequency of report generation (e.g., “report frequency parameters”), the delivery destination and/or format of the report (e.g., “report delivery parameters”), and/or other parameters. In some embodiments, reports may be generated that provide composite statistics for one or more of software applications 101, asses trends in application usage, provide graph presentation, and/or other reporting tasks.

Both data access module 113 and reporting module 115 may be utilized not only for querying and report generation from the of stored summary or statistical data from summary database 109, but both of these modules and/or other modules may be utilized to provide further analysis of summary or statistical data extracted from one or more of software applications 101 and stored in summary database 109. For example, data access module 113, reporting module 115, and/or other modules may also be used to provide one or more of batch reports and graphs, online reports and graphs, trending analysis, and/or other analysis or reporting. Some or all of this data may be utilized for cross-product integration of one or more of the software applications 101, regulatory recording and reporting compliance, configuration management, and/or for other uses.

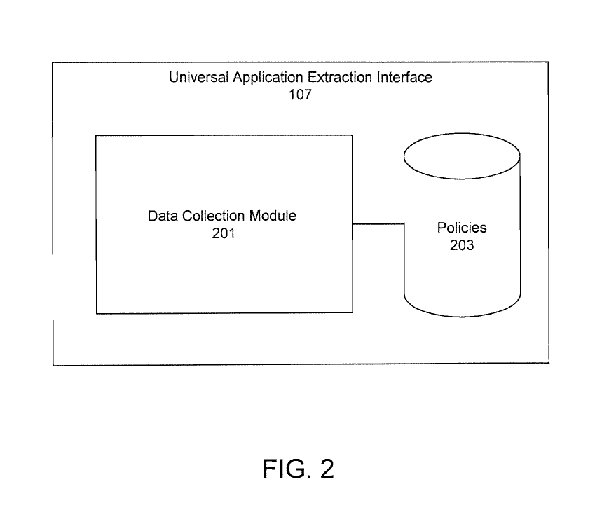

FIG. 2 illustrates universal application extraction interface 107 in greater detail. In some embodiments, universal application extraction interface 107 may include a data collection module 201. Data collection module 201 may enable an administrator or other entity or tool to specify various “data extraction parameters” such as, for example, the specific types of data summarization objects or data categories to be extracted, the specific software applications from which to extract data summarization objects, the specific times or schedules when data summarization objects are to be extracted, the specific formats into which extracted data summarization objects are to be normalized and stored, and/or to specify other characteristics for data summarization object extraction. In some embodiments, data collection module 201 may enable an administrator or other entity or tool to specify one or more extraction parameters via a graphical user interface.

In some embodiments, data collection module 201 may be configured to extract data summarization objects of one or more types from one or more of software applications 101. Examples of these types may include row counts, integer totaling by filter and range totaling by month/day/yea or other types of object. For example, the administrator or other entity may configure data collection module 201 to collect data summarization objects relating to usage of the applications. Usage statistics may include the number of users, the date/time of usage, the duration of usage, the type of data accessed by the user, and/or other usage statistics. Other types of data may be defined and extracted from software applications.

Additionally, data collection module 201 may enable the administrator or other entity to define the specific applications from software applications 101 from which to extract data. For example, the administrator may specify data extraction from all available software applications, may define parameters to capture data from all applications in a select category or those sharing a given characteristic, may select specific applications from which to capture data, or may otherwise define the software applications 101a-101n from which to extract data.

In some embodiments, universal application extraction interface 107 includes policies 203. Policies 203 include foreknowledge of how access to data summarization objects (and/or other objects) is granted by the APIs 103 of each of software applications 101. Data collection module 201 utilizes policies 203 regarding the various application APIs 103 to determine how to go about accessing data summarization objects from software applications 101.

In some embodiments, data collection module 201 may also enable the administrator or other entity or tool to designate data extraction times. For example, data may be extracted at a specific date and time, on a daily, hourly, weekly, monthly, yearly or other basis, upon a specific indication from a user, upon the occurrence of a specified event, or otherwise extracted.

In some embodiments, data collection module 201 may also enable an administrator or other entity or tool to define the format into which extracted data is stored in summary database 109. Because universal application extraction interface 107 may be thought of as a generic API, an administrator may define any format in which to store collected data. As described herein, the normalized statistical summary schema used to store the extracted data summarization objects may be the same for all data. This gives any consumer an easy understanding of interfaces and result sets.

Data collection module 201 may also enable specification of other extraction parameters.

In some embodiments, a system for collecting, storing, analyzing, and/or accessing application summary data from multiple software applications (e.g., system 100 of FIG. 1) may include one or more hardware elements necessary to support the elements, features, and/or functions described herein. For example, the one or more modules, databases, and/or data stores may be loaded or run on one or more computing devices. The one or more computing devices may include one or more servers, personal computers, workstations, laptop computers, personal digital assistants, memory devices, display devices, data input devices, communication devices, and/or other computing devices. Additionally, the system may include additional software (e.g., operating systems, graphical/display support, drivers, or other software) necessary to support the elements, features, and/or functions described herein.

Those having skill in the art will appreciate that the invention described herein may work with various system configurations. Accordingly, more or less of the aforementioned system components/modules may be used and/or combined in various embodiments. In some embodiments, as would be appreciated, the functionalities described herein may be implemented in various combinations of hardware and/or firmware, in addition to, or instead of, software.

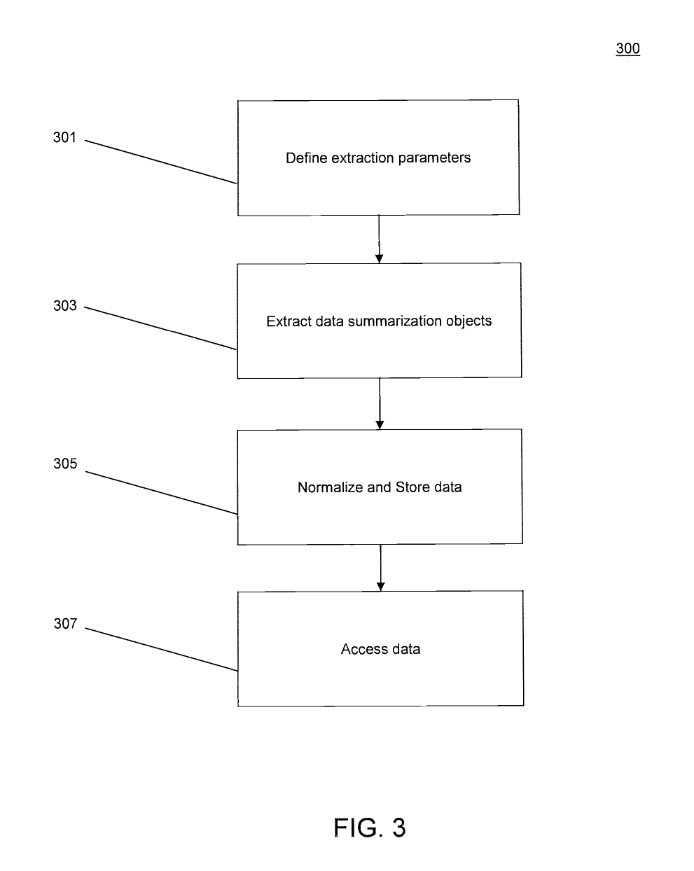

In some embodiments, the invention provides a method for extracting, storing, analyzing, and/or accessing application summary data from multiple software applications. FIG. 3 illustrates a process 300 according to various embodiments of the invention, wherein summary data from multiple software applications may be extracted, stored, and accessed. In an operation 301, one or more data extraction parameters may be defined. As mentioned above, the data extraction parameters may include the type of data summarization objects to be extracted from the one or more software applications 101, the source of the data summarization objects (e.g., which software applications to extract from), the timing of extraction (specific date/time, weekly, monthly, etc.), the format in which the data summarization objects will be stored, and/or other parameters. In some embodiments, an administrator or other entity may define these data extraction parameters.

For example, in some embodiments, the administrator or other entity or tool may define extraction parameters that specify the type of data summarization objects to be extracted from specific software applications 101. As described above, other extraction parameters such as, for example, extraction times or schedules, extraction formats, or other extraction parameters may be defined.

In an operation 303, the defined data summarization objects may be extracted according to the defined extraction parameters. For example, a first set of data summarization objects may be extracted through the API of a first software application and a second set of data summarization objects may be extracted through a disparate API of a second software application.

In some embodiments, the data summarization objects may be extracted on a pre-defined data extraction schedule. As mentioned above, in some embodiments, the extraction schedule may be defined in the extraction parameters. The predefined extraction schedule may be selected depending on any number of factors, including, for example, the needs of statistical or summary querying or reporting, the processing or production of data summarization objects by the relevant software applications 101, and/or other factors. For example, a software application may be accessed by users once a month on average. Therefore, it may not be advisable to extract data on a daily basis, but rather on a monthly basis. Therefore, the extraction schedule of the data extraction parameters may be set to a monthly schedule. Other extraction schedules may be used. In some embodiments, an administrator or other entity may cause data to be extracted at times other than those specified by the extraction schedule.

In an operation 305, the extracted data summarization objects may be normalized into a common format (e.g., a first set of data summarization objects and a second set of data summarization objects, each of which were extracted from two different APIs may be normalized in a common format) and stored in summary database 109 in a normalized schema. In some embodiments the common format may be the format specified by the extraction parameters. While statistical data mining application 105 is able to store any type of data retrieved from any application, normalizing the data enables the stored data to later be universally accessible by statistical data mining application 105. This may not only simplify the mechanisms utilized for querying and reporting purposes (via query module 113 and reporting module 115), but may enable comparison of data between applications where appropriate, aggregation of data from different applications where appropriate, and/or other inter-application uses.

In an operation 307, the stored data may be accessed by one or more users, one or more modules, and/or by other methods. For example, the stored data may be accessed by data access module 113 that performs data access queries using known database access techniques. For example, data access module 113 may enable a user to input query parameters via a graphical user interface and run a query on the stored data according to the query parameters. Query parameters may include, for example, the type of data to be returned by the query, the software application from which the data originated, date ranges, statistic name, and/or any other query parameters.

Additionally, the stored data may be accessed using reporting module 115 to generate one or more reports using the stored data. For example, in some embodiments, reporting module 115 may utilize the results of a query enabled by query module 113 to provide a report regarding those results. In some embodiments, reporting module 115 may enable a user to enter report parameters that specify characteristics of the resultant report or reports. In some embodiments, reporting module may enable an administrator or other entity to enter the report parameters via a graphical user interface.

Report parameters may include “report data parameters” such as, for example, what type of data to use in generation of the report or reports, the software applications of origin of the data objects used in the report or reports, any applicable temporal characteristics data used in the report or reports must have, and/or other data parameters.

In some embodiments, the report parameters may include “report frequency parameters” that dictate the frequency of report generation and/or delivery. These report frequency parameters may include, for example, hourly reports, weekly reports, monthly reports, yearly reports, one time reports, reports generated upon the occurrence of an event, or other report frequency or schedule.

Additionally, report parameters may include “report delivery parameters” such as the destination of the report (who/where to deliver the report, e.g., specific printers, email addresses, mailboxes, voice mailboxes, telephone numbers, fax numbers, or other destination). Other report delivery parameters may include the format of the delivered report such as, for example, an email (e.g., html, plain text, or other electronic document format), a paper printout, a voice message, a facsimile, or other delivery format. Other report delivery parameters, report frequency parameters, report data parameters, or other report parameters may also be specified.

As mentioned above, access to data stored in summary database 109 may be used not only for general querying or report generation, but also for one or more of batch reports and graphs, online reports and graphs, trending analysis, and/or other analysis or reporting. Some or all of this data may be utilized for cross-product integration of one or more of the software applications 101, regulatory recording and reporting compliance, configuration management, and or for other uses.

While the invention has been described with reference to the certain illustrated embodiments, the words that have been used herein are words of description, rather than words of limitation. Changes may be made, within the purview of the associated claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the associated claims.

What is claimed is:

1. A system for extracting, storing and accessing statistical data from a plurality of different software applications, the system comprising:
a summary database;
a universal application extraction interface that extracts data objects from each of the plurality of software applications according to one or more extraction parameters;
a normalization module that converts the data objects extracted by the universal application programming interface into a common format and stores the converted data objects in the summary database; and
a data access module that utilizes the converted data objects from the summary database to return summary data according to one or more query parameters.

2. The system of claim 1, wherein two or more of the plurality of software applications utilize at least two different application programming interfaces respectively, and wherein the universal application programming interface utilizes foreknowledge regarding the at least two application programming interfaces to extract the data objects according to the one or more extraction parameters.

3. The system of claim 1, wherein the one or more extraction parameters include one or more of data object type, data object source, extraction date, extraction time, and data object format.

4. The system of claim 3, further comprising a data collection module that enables a user to specify the one or more extraction parameters.

5. The system of claim 3, wherein the data object format is the common format utilized by the normalization module.

6. The system of claim 1, wherein the one or more query parameters include one or more of data object type and data object source.

7. The system of claim 1, further comprising a reporting module that generates one or more reports using the converted data objects stored in the summary database according to one or more reporting parameters.

8. The system of claim 6, wherein the one or more reporting parameters include one or more of data object type, data object source, report generation date, report generation time, report destination, and report output format.

9. A system for extracting, storing and accessing statistical data from a plurality of software applications, the system comprising:
a summary database;
a universal application extraction interface that extracts data objects from the plurality of software applications according to one or more extraction parameters, wherein two or more of the plurality of applications utilize at least two different application programming interfaces respectively, and wherein the universal application programming interface utilizes foreknowledge regarding the at least two application programming interfaces to extract the data objects according to the one or more extraction parameters; and
a normalization module that converts the data objects received by the universal application programming interface to a common format and stores the converted data objects in the summary database.

10. The system of claim 9, further comprising a data access module that utilizes the converted data objects from the summary database to return summary data according to one or more query parameters.

11. A method for extracting, storing and accessing statistical data from a plurality of software applications, the method comprising:
defining one or more extraction parameters to extract a plurality of data objects from the plurality of software applications, wherein at least two of the software applications from the plurality of software applications utilize at least two different application programming interfaces;
extracting the plurality of data objects from the plurality of software applications using foreknowledge regarding the at least two different application programming interfaces;
converting all of the data objects in the plurality of extracted data objects into a common format; and
storing the converted data objects into a summary database.

12. The method of claim 11, further comprising accessing data from the converted data objects by querying the summary database according to one or more query parameters.

13. The method of claim 12, wherein the one or more query parameters include one or more of data object type and data object source.

14. The method of claim 11, wherein the one or more extraction parameters include one or more of data object type, data object source, extraction date, extraction time, and data object format.

15. The method of claim 14, wherein the data object format is the common format utilized by the normalization module.

16. The system of claim 11, further generating a report regarding data from the converted data objects according to one or more reporting parameters.

17. The system of claim 16, wherein the one or more reporting parameters include one or more of data object type, data object source, report generation date, report generation time, report destination, and report output format.

18. A system for extracting, storing and accessing statistical data from a plurality of software applications, the system comprising:
a summary database;
a universal application extraction interface that extracts at least one first data object from a first application programming interface of a first software application according to one or more first extraction parameters and extracts at least one second data object from a second application programming interface of a second software application according to one or more second extraction parameters;
a normalization module that converts the at least one first data object and the at least one second data object into a common format and stores the converted data objects in the summary database; and
a data access module that utilizes the converted data objects from the summary database to return summary data according to one or more query parameters.
